(19) United States
(12) Patent Application Publication
(10) Pub. No.: US 2025/0354675 A1
(43) Pub. Date: Nov. 20, 2025

(54) THERMAL LIGHT EMITTING DEVICE WITH INTEGRATED FILTER

(71) Applicant: 4K-MEMS SA, St-Blaise (CH)

(72) Inventors: Ross Stanley, Epalinges (CH); Matthias Imboden, St-Blaise (CH)

(21) Appl. No.: 19/107,080

(22) PCT Filed: Apr. 5, 2023
(86) PCT No.: PCT/IB2023/053455

§ 371 Date: Feb. 27, 2025

(30) Foreign Application Priority Data
Sep. 5, 2022 (EP) 22193994.5

(51) Int. Cl. F21V 5/04; F21V 9/08

(52) U.S. Cl. CPC F21V 5/04; F21V 9/08; H05B 3/0033; H05B 2203/032

(57) ABSTRACT

A light emitter module includes a refractory membrane arranged to be heated to a thermal emission temperature such that an emitting surface of the membrane emits radiation in the IR and/or visible spectrum. The radiation is collimated by transmissive optical element adjacent to the emitting surface with a curved exit surface on which an optical filter is deposited. The transmissive optical element may be a planoconvex lens. The disclosure relates also to compound sources with several thermal sources facing an array of micro-lenses with a common plane entry surface on the backside and a plurality of convex surfaces on the forward side, each covered by an optical filter.

### TECHNICAL DOMAIN

The present invention concerns a thermal light emitting (thermal emitter in the following) device made from a refractory material. This device can emit broadband visible and infrared radiation at high temperatures, e.g., at temperatures higher than 1600 K and/or going up to 3000 K or more.

### RELATED ART

In the present disclosure, the wordings “infrared radiation”, “infrared light” or “IR light” will be considered equivalent and denote a electromagnetic radiation with a wavelength belonging to the range from 0.8 μm to 12 μm, while visible light has a wavelength belonging to the range 0.4 μm to 0.8 μm. Broadband emitters are considered emitters of infrared radiation if a significant part of the radiation energy is within these wavelengths, even if they may emit also in other region of the electromagnetic spectrum.

Thermal emitters rely on the emission of electromagnetic radiation from hot bodies. They are applied in the art to diverse applications comprising for example infrared spectroscopy, illumination for gas sensing, hyperspectral imaging, machine vision, photoacoustic, gas sensing, spectroscopy, and many other. Examples of known thermal emitters are described in the patent applications WO2020012042, WO2021144463 or WO2021144464 filed by the applicant.

Radiation emission from hot bodies is modelled by the blackbody theory of radiation that provides the emission spectrum for each given temperature. To account for the fact that no real materials is truly black, however, the radiation intension needs to be scaled by a parameter called the emissivity, E, which is a function of wavelength and temperature.

Some thermal emitters are based on low-emissivity materials that approximate the behaviour of an ideal black body, with an ε at the wavelength range of interest close to 1. The choice of such high-emissivity material is rather limited, however, and most of them cannot withstand very high temperatures. Selecting a high-emissivity material of this kind that can survive to temperatures above 2000 K is a challenge.

Other thermal emitters are made from a refractory material. A refractory material is a material with a melting point above 2000 K. Examples of refractory materials are the refractory metals, such as Tungsten, Titanium, Hafnium, Zirconium, Tantalum and Molybdenum, as well as compounds that exhibit a high melting point and are stable at temperatures of 2000 K. Refractory materials include many Nitrides, Oxides and Carbides of the refractory metals and of other elements. By extension, any solid component that is capable of being heated without damage to 2000 K or more can be said to be “refractory”.

At IR wavelength refractory metals are quite reflective (Reflectivity ranging from 30% to more than 99%) and the corresponding emissivity belongs in general to the range of 0.7 to 0.01. The advantage of refractory metals is that they are stable at high temperature, the disadvantage is their low intrinsic emissivity.

Flat thermal emitter devices, i.e., thermal emitter devices comprising a substantially flat emitting membrane, are Lambertian emitters: the radiant intensity is proportional to the cosine of the angle between the observer's line of sight and the surface normal. Wire thermal emitter devices are Lambertian on one axis (in general, the axis of the filament) and uniform on a second axis. For a Lambertian emitter, most of the power is being emitted in a cone at 45°.

A thermal light emitting device comprises in general a housing, mainly to protect the incandescent emitter. Most materials, including Tungsten, react readily with atmospheric gases (O₂, N₂, CO₂) at high temperature. To prevent this, the emitter may be in an evacuated space, which also minimise thermal losses. The housing could also be filled with a gas composition based on an inert gas, such as Argon or Xenon.

The housing can include elements to enhance the performance of the thermal emitter in an optical system. A common issue is how to get light from the thermal emitter into the optical system. To use most of the available power, light at very high angles (i. e. to angles higher than 60° or lower than −60°) should be collected. It is also desirable to make the thermal emitter device as compact as possible.

A common solution, used notably for wire thermal emitter devices, is to place the thermal emitter device into a parabolic reflector. However, if the size of the parabolic reflector (or mirror) is close to the thermal emitter device size, then shadowing occurs, i.e., the thermal emitter device itself blocks the light reflected from the parabolic reflector. Moreover, this solution is not suitable for flat thermal emitter devices. Finally, the parabolic reflector has low efficiency for collecting light from the top side of the thermal emitter device.

Another approach is just to use a lens, comprising a first lens surface and a second lens surface (opposite to the first lens surface), at least one lens surface facing one of the surfaces of the thermal emitting membrane. The lens should be very large to maximize the collected light. However, in this case, light at high angles is lost due to reflection.

By assume a Lambertian thermal membrane emitting with a random polarization, some light is lost at the first lens surface due to reflection. Another fraction is lost at the second lens surface.

The normal way to overcome these losses is to reduce the reflections using an anti-reflective coating. Some documents disclose the use of a reflective layer placed under the membrane to improve the emissivity of the emitter (US2021246016 A1 or AT 519870 B1) or on side walls of the emitter device (US2019195602 A1).

However, anti-reflective coatings are expensive, they are complicated to fabricate for wide wavelength ranges, and have a limited range of angles over which they work. Finally, anti-reflective coatings are clearly not ideal when dealing with thermal sources, as the wavelength range is large e.g., 1 μm-3.5 μm, and the range of emitting angles is also very large (Lambertian source).

Other broadband techniques involve subwavelength structures such as the so-called “moth eye structures”. Moth-eye structures are also expensive to fabricate and are generally not available in standard commercial processes.

The spectrum of thermal radiation is intrinsically broad. Optical filters can be used to select some wavelengths and discard others in applications that benefit from a narrower spectrum. Thin film interference filters are often used in this function. Commonly used bandpass filters transmit light over a limited range of wavelengths and block radiation outside the pass region. A bandpass filter can be characterized by its central wavelength of the pass range (CWL), its width, often expressed by the FWHM (full width half-maximum) parameter and its attenuation in the side bands, often expressed by an optical density OD (OD=log₁₀(I/T), where I and T denote the incident and transmitted intensities).

Thin film interference filters, also known as dichroic filter, are widely used to filter light and infrared radiation in a wide range of applications. Many interference filters comprise a stack of thin layers of dielectric materials having different refractive indices Their parameters depend on the incidence angle, however. At small angles from the normal, the centre wavelength shifts. At larger angles, one observes a change in performance with the polarization, and at even larger angles the filters no longer function as such. Angle dependence is not an exclusive problem of interference filter, however, and all commonly used filter exhibit it in some measure.

This dependence on the incidence angle means that interference filter work best if the incident light is relatively well collimated. The angular dependence limits the etendue (one measure of etendue is the product between the aperture area and the square of the numeric aperture) and hence the efficiency. If the filter is put near a detector, the detector should be large to compensate for the reduced numeric aperture, while, if the filter is near the emitter, a collimating optics will in general be required, which adds to the size.

Therefore, there is a need of a thermal emitter device with an integrated filter providing a filtered radiation without the shortcomings and limitations of the state of the art.

### SHORT DISCLOSURE OF THE INVENTION

An aim of the present invention is the provision of a thermal emitter device that overcomes the shortcomings and limitations of the state of the art.

Another aim of the invention is the provision of a thermal emitter device that is more flexible than conventional sources, because it has an integrated filter, yet is compact, efficient, and easily produced.

According to the invention, these aims are attained by the object of the attached claims, and especially by a thermal emitter device according to claim 1. In particular, by a light emitter module comprising a refractory membrane arranged to be heated to a thermal emission temperature such that an emitting surface of the membrane emits radiation in the IR and/or visible spectrum, a transmissive optical element adjacent to the emitting surface comprising a curved surface configured such that at least a part of the radiation from the emitting surface enters the transmissive optical element and crosses the curved surface, characterised by an optical filter on the curved surface.

Dependent claims introduce additional features and limitation that may be useful or important, but are not essential to the working of the invention, such as the facts that the optical filter is an interferential filter, that the curved surface is a convex surface, that the transmissive optical element is a planoconvex lens, that the distance between the transmissive optical element and the emitting surface is equal or lower than L/4, or equal or lower than L/8. The curved surface may be surrounded by a blocking aperture to reflect stray radiation back towards the source.

In the invention, the transmissive optical element can be made of any suitable IR-transparent material, such as glass, silicon, sapphire, quartz, germanium, and/or a MID-Far thermal material, such as CaF₂, MgF₂, ZnSe, ZnS, NaCl. The refractory membrane can be made by a refractory material, a refractory metal or alloy or a refractory ceramic.

Importantly, the emitting module can be combined in arrays to form compound emitter devices for higher intensity, improved collimation, or to have a control on the emitted wavelength, if the optical filters of the thermal emitting modules have different central wavelengths and/or pass bandwidths.

The present disclosure also concerns an emitter device including a thermal emitting membrane with a surface. The thermal emitting membrane is arranged to be heated to a thermal emission temperature so that the surface radiates IR or visible light.

In this context, the term “membrane” designates an element whose thickness is lower than its other two dimensions. In this context, the term “membrane” is a synonymous of the term “(hot)-plate”. In this context, a membrane is arranged to keep its own shape independently on the temperatures and it is held at several points. In other words, in this context, a membrane does not buckle nor break at high temperatures. In one preferred embodiment, the membrane is substantially planar. In one preferred embodiment, the membrane can support itself, i.e., it is structurally independent. In another embodiment, the membrane cannot support itself, unless attached on all sides.

The intrinsic emissivity of the surface may be lower than 0.7. In fact, the invention is useful for low-emissivity materials, i.e., for materials having an emissivity lower than 0.7. In other words, there is not so much interest for enhancing the emissivity of good emitter materials, i.e., of materials having an emissivity equal or higher than 0.7.

The thermal emitter device may include a lens, the lens comprising a lens surface, the lens surface facing the surface of the thermal emitting membrane and having a reflectivity normal to the lens surface comprised in the range 4% to 40%, to partially reflect the radiated IR or visible light. The lens may be flat, that is delimited by two plane and essentially parallel surfaces, or non-flat, for example the lens could have a convex shape.

Advantageously, the distance between the lens surface and said one of the first or second surfaces is equal or lower than L/4, where L is a major length of the thermal emitting membrane. In other words, according to the invention the lens is placed “close” to the thermal emitter device. In this way, a part of the IR or visible light reflected by the lens is reabsorbed by the thermal emitting membrane, and another part of the light reflected by the lens is reflected by the thermal emitting membrane toward the lens, having therefore another chance to go through the lens, thereby increasing the efficiency the thermal emitter device.

Since the efficiency is increased, then for a fixed radiance it is possible to lower the temperature. Thermal emitters operating at lower temperatures will typically have a longer operating lifetime. In other words, a user who requires a specific spectral radiance will lower the operating temperature and hence improve the lifetime.

No thermal emitter can attain the emissivity of a perfect black body. Many devices disclosed herein have an emissivity lower than 0.7 depending on wavelength and material or, equivalently, reflect 30% or more of the incident radiation. Advantageously, the thermal emitter device is placed “close” to a partially reflective lens: therefore, a part of the emitted light goes through the lens, and another part of the emitted light will be reflected by the lens, will hit an emitter surface, and either will be reabsorbed by the thermal emitter device or will reflected by the thermal emitter device towards the lens, having then a second chance to go through the lens.

Thanks to the reflection of the thermal emitter device, there is then an improvement in transmission. Moreover, there is an additional gain since the remaining power is not lost as it is absorbed by the thermal emitter device and therefore increases the efficiency of the emitter and/or its lifetime.

Preferably, the thermal emitting membrane is made by or comprises a refractory material, e.g., a refractory metal, a refractory ceramic (such as carbides or nitrides) and/or an alloy of refractory metals.

The distance between the lens and the surface of the emitting membrane may be equal or lower than L/4 (or L/8). This brings the lens closer to the emitting membrane, increases the efficiency further, and improves the lifetime of the thermal emitter device.

The lens may be made of glass, silicon, sapphire, quartz, germanium, and/or a MID-Far thermal material, such as CaF₂, MgF₂, ZnSe, ZnS, NaCl. Advantageously, the thermal emitter device may include a lid on which and the lens is placed in or on the lid. Otherwise, the lens itself may be the lid.

The lens may comprise a lens entry surface as well as a lens exit surface and may be “thin”. In this case, the thickness of the lens is such that the lens exit surface is also be deemed as being “close” to the emitter surface. In this embodiment, when calculating the thickness of “thin” lens, the refraction of light in the lens material should be considered and the lens apparent thickness should be used. In the present disclosure, a lens is deemed to be “thin” when its apparent thickness—corrected in consideration of the incidence angle—is less than L/4 (or L/8), L denoting the largest dimension of the emitting membrane. The lens apparent thickness can by computed by known formulas, knowing the refractive index and the angle of incidence. For an angle equal to 45°, the lens apparent thickness formula is the real thickness of the lens, multiplied by a scale factor equal to 1/ \sqrt{2n²−1}.

Otherwise, the lens could be “thick”, with an apparent thickness larger than L/4 (or L/8). In this case, however, the distance between the lens entry surface and a (first) surface of the thermal emitting membrane, is still preferably less than L/4 (or L/8).

Advantageously, the curvature of lens exit surface may be chosen to refocus the light back to the emitter and/or for making the emission more directional.

Optionally, the thermal emitter device comprises a mirror on at least a portion of the lens exit surface. The mirror may be off-axis. This wording indicating that the mirror is not symmetrically placed with respect to a symmetry axis of the lens. The mirror could be a cold mirror, i.e., a mirror whose reflectivity normal to the mirror surface is higher than 80% (i.e., it is a highly reflecting mirror). Advantageously, the mirror comprises an opening and a portion of the lens facing the opening may present a shape different from the shape of the lens which does not face the opening, to control the emitted light further.

The membrane of the thermal emitter device may be suspended by a plurality of resistive or conductive arms connected thereto. The arms also serve to conduct an electric current that heats the membrane to a desired temperature for the thermal emission.

The membrane may present two opposed surfaces, a first and a second one, that both radiate in the infrared when the membrane is at the desired temperature. The mirror may face one of the opposed surfaces.

Advantageously, at least a portion of the thermal emitting membrane comprises holes, for example through holes. In some arrangements, any cross section in a plan parallel to one of the first or second surfaces of the thermal emitting membrane of said holes has a maximum dimension larger than the longest wavelength of said predefined region, and the sum of the areas of the holes is at least 10% of the area of each of the first or second surfaces of the thermal emitting membrane.

### SHORT DESCRIPTION OF THE DRAWINGS

Embodiments of the invention are disclosed in the description and illustrated by the drawings in which:

FIGS. 1 to 3 illustrate a cut view of thermal emitter devices.

FIG. 4 illustrates a cut view of a thermal emitter device comprising a “thin” lens, while

FIG. 5 illustrates a cut view of a “thick” lens of a thermal emitter device.

FIG. 6 shows a cut view of the “thick” lens of a thermal emitter device of FIG. 5 as well as the light propagation beyond the lens exit surface.

FIG. 7 illustrates a cut view of a “thick” lens of a thermal emitter device and a mirror on a portion of the lens exit surface.

FIG. 8 illustrates schematically a thermal emitter system comprising a cold mirror, i.e., with a mirror that does not emit at the wavelength of interest.

FIGS. 9 to 11 show a cut view of a thermal emitter device with an off-axis mirror on the lens exit surface.

FIG. 12 shows a perspective view of part of a thermal emitter device according to another embodiment of the invention.

FIG. 13 illustrates a cut view of a thermal emitter device with a filter.

FIGS. 14 and 15 relate to a compound thermal emitter with four emitting modules and four corresponding lenses.

In the figures, remarkable elements are identified by reference signs that are repeated in the text. The same reference sign may be used to identify distinct elements that are identical, similar or technically equivalent. When many identical, similar or equivalent elements are present, some reference signs may have been omitted to avoid overcrowding the figures.

### EXAMPLES OF EMBODIMENTS OF THE PRESENT INVENTION

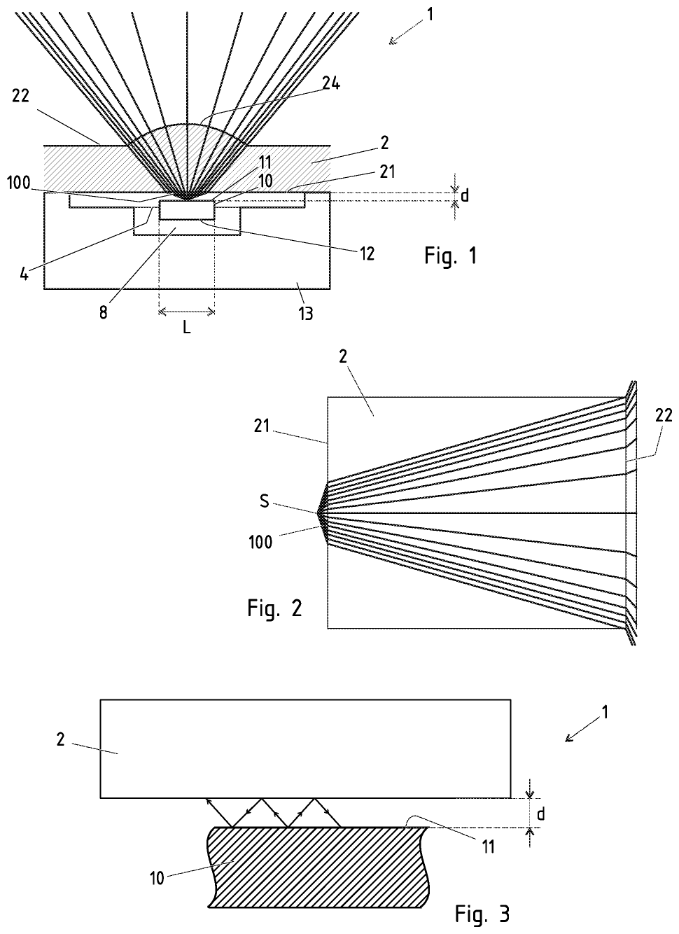

FIG. 1 illustrates a cut section of a portion of a thermal emitter device 1 that may be part of embodiments of the invention. In this embodiment, the thermal emitter device 1 comprises a thermal emitting membrane 10 comprising a first surface 11 and a second surface 12, the second surface 12 being opposite to the first surface 11, wherein the thermal emitting membrane 1 is arranged to be heated to a thermal emission temperature so that the first and second surfaces 11, 12 radiate light 100 at the thermal emission temperature. The size and the proportion of the different elements illustrated in FIG. 1 are just indicative and do not necessarily correspond to the real size respectively proportion.

The emissivity ε of a surface, for example of the first surface 11, will vary according to the material chose, the surface state and the wavelength, and is lower than 0.7 in most cases. In embodiments, the membrane 10 may be monolithic or the first and second surfaces may be made by the same material in which case the second surface 12 will have the same emissivity ε as the first surface 11. In other embodiments, the first and second surfaces 11, 12 are made by different materials with different emissivity, both lower than 0.7. Non limitative examples of material having an emissivity lower than 0.7 in the IR and visible spectrum comprises refractory metals such as Tungsten, Titanium, Hafnium, Zirconium, Tantalum, Molybdenum, their alloys, their Nitrides, Oxides and Carbides.

Although the first and second surfaces 11, 12 have been represented as parallel, this is not essential for the invention. Although the first and second surfaces 11, 12 have been represented as substantially plate-like, again this is not essential for the invention. However, the invention is particularly adapted for a flat thermal emitting membrane 10.

In the illustrated device, the thermal emitting membrane 10 is a single piece membrane. In other (not illustrated) embodiments, the thermal emitting membrane 10 may have a multi-layer structure comprising at least one layer (of a different material) between the first and second surfaces 11, 12.

In FIG. 1, the thermal emitter device 1 comprises a plurality of resistive arms 4 connected to the thermal emitting membrane 10 and connecting the thermal emitting membrane 10 to a support 13. The thermal emitting membrane 10 is suspended by the resistive arms 4, and it is heated to a thermal emission temperature via those resistive arms 4.

Importantly, the thermal emitter device 1 comprises also a lens 2 that comprises a lens entry surface 21, which faces the first surface 11 of the thermal emitting membrane 10 in FIG. 1. The lens 2 comprises a lens exit surface 22, opposite to the lens entry surface 21.

In the embodiment of FIG. 1, the lens entry surface 21 is substantially flat and the lens exit surface 22 comprises a curved portion 24, in this example, the curved portion 24 is convex.

In the embodiment of FIG. 1, the lens is monobloc and made by the same material. In other embodiments, the lens could comprise two or more pieces and/or could be made of different materials. In one embodiment, a (plano-convex) lens is placed on the lid, e. g. with glue or any other adapted fixation means.

In the embodiment of FIG. 1, the thermal emitting membrane 10 is placed in a housing 8 defined by the lens 2 and the support 13. In one embodiment, this housing 8 comprises vacuum or a controlled atmosphere e.g., without oxygen or other gases which would react with the emitting material at high temperature.

In embodiments, the lens 2 has a reflectivity normal to a lens surface, e. g., the lens entry surface 21, comprised in the range 4% to 40%, to partially reflect the radiated light. It may be made of glass, silicon, sapphire, quartz, germanium, and/or a MID-Far thermal material, such as CaF₂, MgF₂, ZnSe, ZnS, NaCl.

According to the invention, the distance d between the lens entry surface 21 and the first surface 11 of the thermal emitting membrane 10 is equal or lower than L/4, where L is a major dimension of the thermal emitting membrane 10.

If the thermal emitting membrane 10 has a rectangular section, its major dimension L is the longer side of the rectangular section. If the thermal emitting membrane 10 has a circular section, its major dimension L is the diameter of the circular section.

In other words, it is preferred that the lens 2 be placed “close” to the thermal emitter device 10. In this way, a part of the light reflected by the lens 2 is reabsorbed by the thermal emitting membrane 10, and another part of the light reflected by the lens 2 is reflected by the thermal emitting membrane 10 toward the lens 2, having therefore another chance to go through the lens: this allows to increase the efficiency and/or the lifetime of the thermal emitter device.

According to one embodiment, the distance d between the lens entry surface 21 and the first surface 11 of the thermal emitting membrane 10 is equal or lower than L/8. In this embodiment, the lens 2 is closer to the thermal emitting membrane 10, thereby increasing more the efficiency and/or the lifetime of the thermal emitter device.

In one embodiment, the thermal emitter device 1 comprises a lid and the lens 2 is placed in or on the lid.

Using a lens 2 close to the thermal emitting membrane 10 changes the angle dispersion of the thermal emitted light. The refraction at the interface between the housing 8 and the lens entry surface 21 allows to convert all angles, so that all light propagates at angles less than a maximum angle related to the angle of total internal reflection at surface 21 due to the material of the lens 2 a. For example, if the lens is made of glass, the maximum angle is about 40°; if the lens 2 is made of in silicon, the maximum angle is about 16°.

FIG. 2 illustrates a cut view of a lens 2 of a thermal emitter device according to another embodiment of the invention. In this embodiment, the lens 2 is made by silicon and comprises an entry surface lens 21 and an exit surface lens 22 substantially parallel to the entry surface lens 21, both the entry surface lens 21 and the exit surface lens 22 being substantially flat.

By assuming a Lambertian source S emitting at, for example, a wavelength of 1.5 microns with a random polarization (and schematically representing a thermal emitting membrane 10), then about 32% of the light is lost at the lens entry surface 21 due to reflection. A slightly smaller fraction 27% is lost at the lens exit surface 22. The total transmission of the lens therefore 50%:

$$0.5 = ( 1.000 - 0.315 ) \times ( 1.00 - 0.27 ) \qquad ( 1 )$$

Instead of considering this loss as a drawback to be improved, e.g., by using anti-reflective coating, the thermal emitter device 1 according to the invention exploits those reflections, by using a thermal emitting membrane 10 which is not a perfect blackbody.

The thermal emitting membrane 10 has emissivity of lower than 0.7, depending on wavelength and material. This means it has a reflectivity of 30% or higher. According to the invention, the thermal emitting membrane 10 is placed close to the lens; therefore, the light reflected from the lens 2 will hit the first surface 11 of the thermal emitting membrane 10, and either be reabsorbed by the thermal emitting membrane 10 or reflected by the thermal emitting membrane 10 towards the lens, which then has a second chance to go through the lens 2.

Let Tₗₑₙₛ being the transmission of the first surface of the lens 21, then the light transmitted at the first pass is simply Tₗₑₙₛ. Let Rₗₑₙₛ being the light reflected by the lens. After reflection Rₗₑₙₛ from the thermal emitting membrane 10 with reflectivity Rₑₘᵢₜₜₑᵣ then after one round trip and additional Rₗₑₙₛ Rₑₘᵢₜₜₑᵣ of light will impinge on the lens 2. Therefore, the total light transmitted after first pass and a single round trip is

$${T}_{lens} ( 1 + {R}_{lens} {R}_{emitter} ) , \qquad ( 2 )$$

and after n round trips it becomes:

$${T}_{lens} ( 1 + {R}_{lens} {R}_{emitter} + {( {R}_{lens} {R}_{emitter} )}^{2} + … + {( {R}_{lens} {R}_{emitter} )}^{n} ) \qquad ( 3 )$$

Table 1 indicates the total light transmitted after a certain number of round trips, for a thermal emitter device having an emissivity equal to 0.4 and a reflectivity Rₑₘᵢₜₜₑᵣ equal to 0.6, and Table 2 indicates the total light transmitted after a certain number of round trips, for a thermal emitter device having an emissivity equal to 0.2 and a reflectivity Rₑₘᵢₜₜₑᵣ equal to 0.8:

TABLE 1

| No of round trips | Transmission |
|---|---|
| 0 | 68.49% |
| 1 | 81.43% |
| 2 | 83.88% |
| 3 | 84.35% |
| N | 84.45% |

TABLE 2

| No of round trips | Transmission |
|---|---|
| 1 | 85.75% |
| 2 | 90.10% |
| 3 | 91.20% |
| N | 91.57% |

These two examples show that most a considerable improvement in transmission occurs via reflection from the thermal emitting membrane 10. As discussed, there is also an additional gain in that the remaining power is not truly lost as it is absorbed by the thermal emitting membrane 10 and therefore increases its efficiency.

The applicant has found that two round trips are enough to give most of the gain from light being reflected from thermal emitting membrane 10. A “close” distance between the lens 2 and the thermal emitting membrane 10 have been defined based on those considerations.

FIG. 3 illustrates a cut view of a thermal emitter device 1 according to another embodiment of the invention.

Complete numerical simulations with ray-tracing software performed by the applicant with a thermal emitter device according to the invention, a lens 2 having an index of refraction of 3.5 and a thermal emitting membrane 10 having an emissivity of 0.4 show that up to 84.4% of thermal emitted light can be transmitted thought the lens 2, and the other 15.4% is absorbed by the thermal emitting membrane 10.

A similar advantage can be obtained by exploiting the lens exit surface 22, if the lens 2 is “thin”. In other words, the thickness of the lens 2 is such that lens exit surface 22 can also be deemed as being close to lens entrance surface 21 as defined above.

Complete numerical simulations with ray-tracing software performed by the applicant show that the transmission through the thermal light emitting device according to the invention is enhanced if the lens 2 itself is “thin”.

In this context, a lens 2 is “thin” if the lens apparent thickness is less than L/4 (or L/8). In this embodiment, the distance between the lens entry surface 21 and the surface 11 of the thermal emitting membrane, is less than L/4 (or L/8).

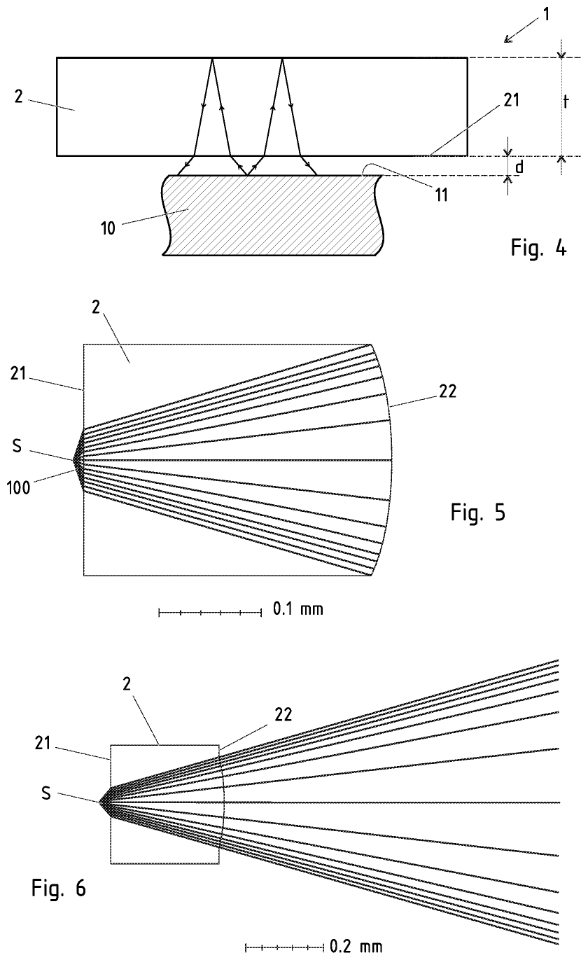

FIG. 4 illustrates a cut view of a thermal emitter device 1 comprising a “thin” lens 2, according to another embodiment of the invention. The refractive index of the lens 2 is taken to be around 3.5 in FIG. 4.

For example, with a lens material with an index of refraction of 3.5, light at 45° is refracted to 11.6°. The tan of 11.6° is 0.2. More specifically, the thickness is the apparent thickness of the lens when viewed at 45°. For example, if the refractive index, n, is 3.5 then the scale factor is 0.21, so the window appears 0.21 times closer than in reality. For n=1.5, the scale factor is 0.53.

Complete numerical simulations with ray-tracing software performed by the applicant with a thermal emitting membrane 10 of 100 μm in diameter show that the lens entry surface 21 should be 20 μm away from its first surface 11 for it to be close. The scaled thickness of the thin lens should be likewise 20 μm. For an index of 3.5 this would mean that the real thickness of the lens could be 20/0.21=95 μm.

In one embodiment, the entry and the lens exit surfaces 21, 22 of a “thin” lens 2 are substantially flat.

FIG. 5 illustrates a cut view of a “thick” lens 2 of a thermal emitter device according to another embodiment of the invention. The showed map scale gives just an indication of a possible size of the “thick” lens 2 and should not be considered as limitative.

In the embodiment of FIG. 5, the lens exit surface 22 is (at least partially) curved, to refocus via reflection at least part of the light back onto the thermal emitting membrane 10. In one embodiment, at least a portion of the lens exit surface 22 is convex. In the embodiment of FIG. 5, all the lenses exit surface 22 is convex.

Tests performed by the applicant show that the net transmission with a “thick” lens 2 can be estimated to be about 71% with the remaining 29% being reabsorbed by the thermal emitting membrane 10.

There is an additional advantage to use a lens 2 comprising an exit curved lens exit surface 22. Not only does it enhance the efficiency of the thermal emitter device 1, but it also makes the emission more directional.

Tests performed by the applicant show that for a lens having an index of refraction of 3.5, the angular spread of the light beams is +/−11.6° simply by refraction at the lens entry surface. The numerical aperture NA of the thermal emitting membrane 10 has been changed from 0.95 to about 0.2, which has a huge advantage in many applications as no other external optical elements are needed.

In one embodiment, the thermal emitter device 1 comprises an external optics to collimate further the emitted light.

FIG. 6 illustrates a cut view of the “thick” lens 2 of a thermal emitter device 1 of FIG. 5, with an embodiment of the light propagation beyond the lens exit surface. In the illustrated embodiment, the beams are not deviated at the lens exit surface 22. In another (not illustrated) embodiment, the beams could be deviated at the lens exit surface 22. The showed map scale gives just an indication of a possible size of the “thick” lens 2 and should not be considered as limitative.

In order to restrict the opening of the lens 2, it is possible to either change the shape of the lens 2 or put a mirror on a portion part of the exit surface 22 of the lens. This mirror will block light and reflect it back onto the thermal emitting membrane 10, with the double advantage that the light can be reflected from the thermal emitting membrane 10 or reabsorbed in the thermal emitting membrane 10.

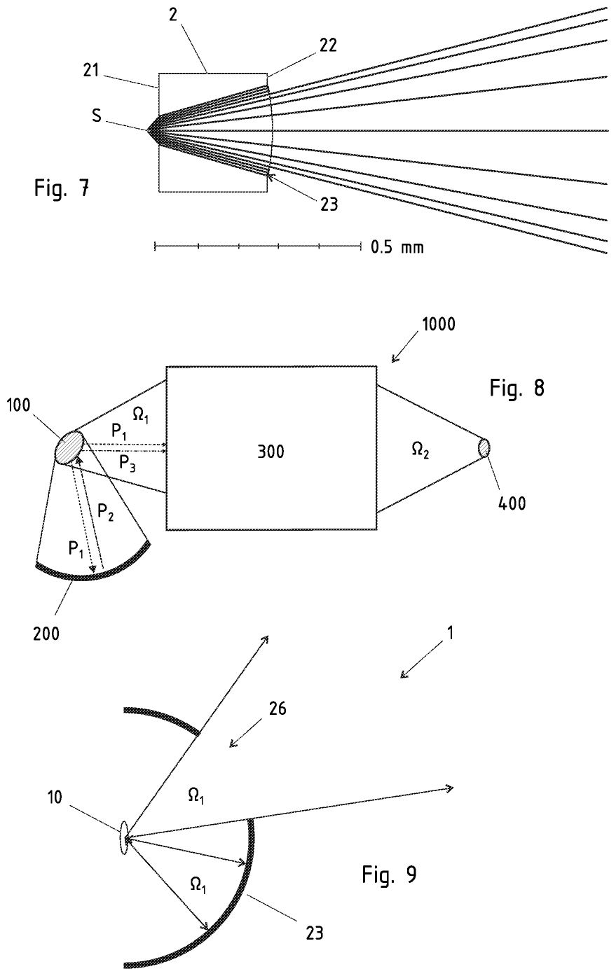

FIG. 7 illustrates a cut view of a “thick” lens 2 of a thermal emitter device, comprising a mirror on a portion 23 of the lens exit surface 22, according to another embodiment of the invention. The showed map scale gives just an indication of a possible size of the “thick” lens 2 and should not be considered as limitative.

In the embodiment of FIG. 7, the lens exit surface 22 comprised a curved portion 24. The mirror 23 is placed at the two ends of the curved portion 24, by restricting therefore the exit angle of the light beam, thereby improving its directionality.

In one preferred embodiment, the thermal emitting membrane 10 (not visible in FIG. 7) is curved. This allows to increase more the number of trips on the emitted light in the lens 2.

In order for the light reflected from the mirror 23 on the lens 2 and for the light reflected from the thermal emitting membrane to escape, in one embodiment, the mirror portion 23 is slightly defocused, i.e., the emitter is not placed at the exact focal point, the blur should remain small on a scale of the emitter dimension; in another embodiment, the thermal emitting membrane is slightly curved (bowed upwards towards the lens), so that the light reflected from the mirror 23 does not retract exactly the original path. The bowing should be small on the scale of the scale of the emitter dimension.

Tests performed by the applicant show that a bowed mirror 23 couples the light reflected from the mirror 23 into the escape cone, thereby directly improving the efficiency of the thermal emitter device.

In one embodiment, the mirrored portion 23 comprises an off-axis aperture on the exit lens surface. This allows to improve the device emissivity.

In one embodiment, the device emissivity is improved by using a using a (cold) mirror.

FIG. 8 illustrates schematically a thermal emitter system 1000 comprising a cold mirror 200, i.e., with a mirror that does not emit at the wavelength of interest. Although in FIG. 8 the mirror is illustrated as a curved one, the invention is not limited to a curved mirror, but include any shape of mirrors, comprising e.g., flat mirrors. The size and the proportion of the different elements of FIG. 8 are just indicative and do not necessarily correspond to the actual size respectively proportion. The same applies to the inclination of the depicted arrows.

For an absorbing material ε=1−Rₘ, where Rₘ is the reflectivity of the material. By reflecting some of the light emitted from the material back off the same surface, then it is possible to increase the effective emissivity.

This embodiment is based on the reflection by the cold mirror 200 of some of the light emitted from the first thermal emitter device 100 back off the same surface to increase the effective emissivity or the first thermal emitter device 100.

Let P₁ being the power emitted by the first thermal emitter device 100 towards the optic 300 and towards the mirror 200. Then:

$${P}_{1} = ε {dA}_{1} {Ω}_{1} \qquad ( 4 )$$

The power reflected back by the cold mirror 200 having a reflectivity R towards the first thermal emitter device 100 is then equal to:

$${P}_{2} = R ε {dA}_{1} {Ω}_{1} \qquad ( 5 )$$

The power P₂ reflected by the cold mirror 200 is then reflected by the emitter as P₃:

$${P}_{3} = {R}_{m} R ε {dA}_{1} {Ω}_{1} \qquad ( 6 )$$

where Rₘ is the reflectivity of the material of the first thermal emitter device 100.

Therefore, the total power towards the optics 300 is P₁+P₃ and is equal to:

$${P}_{1} + {P}_{3} = ε {dA}_{1} {Ω}_{1} ( 1 + {R}_{m} R ) \qquad ( 7 )$$

The total emission power is conserved, less possible loss in the mirror 200. The power towards optic can never exceed dA₁·Ω₁, so that the second law of thermodynamics is satisfied.

The thermal emitter device according to one embodiment of the invention is an implementation of the idea depicted in FIG. 8.

FIG. 9 illustrates a cut view of a thermal emitter device 1 according to one embodiment of the invention, comprising an off-axis mirror 23. The mirror comprises an opening 26. The thermal emitter device 1 of FIG. 9 comprises also a (not-illustrated) lens, according to the disclosure.

In the embodiment of FIG. 9, the emission in a cone 21 towards the mirror 23 is reflected back on to the thermal emitting membrane 10. Part of the power is reabsorbed in the thermal emitting membrane 10 and part of the power is reflected out through the opening 26, which sums with the original power emitted towards the opening 26, thus enhancing the power out.

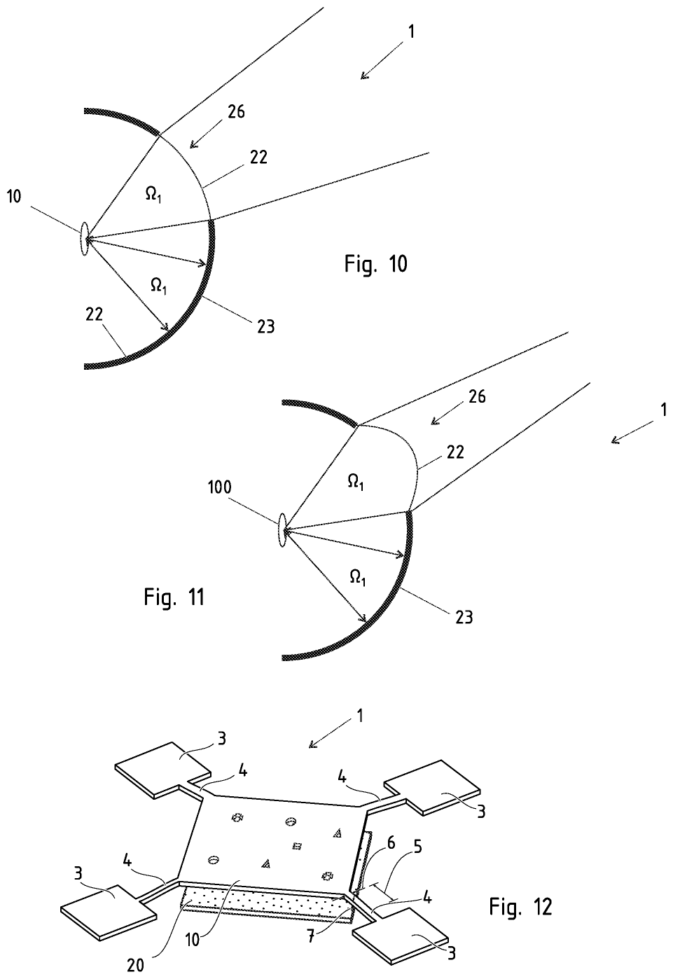

FIG. 10 illustrates a cut view of a thermal emitter device 1 according to another embodiment of the invention, comprising an off-axis mirror on the lens exit surface 22.

In this embodiment, the opening 26 is on the lens exit surface 22 22 so the light is more directional. This embodiment combines the advantage of a (close) lens (to collect angles) along with the mirror 23 to reflect light off the sample.

FIG. 11 illustrates a cut view of a thermal emitter device 1 according to another embodiment of the invention, comprising an off-axis mirror on the lens exit surface 22.

In this configuration, the opening could have a different shape to the rest of the lens 2, to control the light further.

FIG. 12 shows an example of a thermal emitter device 1 according to the invention, wherein the thermal emitting membrane 10 comprises a plurality of resistive arms 4 connected to the thermal emitting membrane 10, wherein the thermal emitting membrane 10 is suspended by the resistive arms, wherein the thermal emitting membrane 10 is heated to a thermal emission temperature via those resistive arms 4. Each of the arms 4 in the illustrated example of FIG. 12 has a length 5, a width 6 and a thickness 7, and a cross-sectional area which is much smaller than that of the membrane 10. The connection pads 3 are designed to provide mechanical connection to a substrate such that the membrane 10 is only supported relative to the substrate by the arms 4 and pads 3. The connection pads 3 provide electrical connection to the arms 4, and thereby to the membrane 10. The membrane 10, pads 3 and arms 4 are preferably made of a single contiguous piece of material. Other features and other embodiments of this thermal emitter device 1 and/or of this emitting membrane 10 are described in the documents WO2020012042, WO2021144463 or WO2021144464 filed by the applicant and enclosed here by reference.

Advantageously, the thermal emitter device may be manufactured at the micrometer scale on a wafer substrate.

In the embodiment of FIG. 12 the membrane 10 comprises different holes, as described in the patent application having the application number EP20220155542 filed by the applicant, and here enclosed by reference.

The presence of the holes on the membrane 10 as described in the patent application having the application number EP20220155542 is not limited to the embodiment of FIG. 12, but it applies also to the other embodiment of the present invention which comprise a mirror.

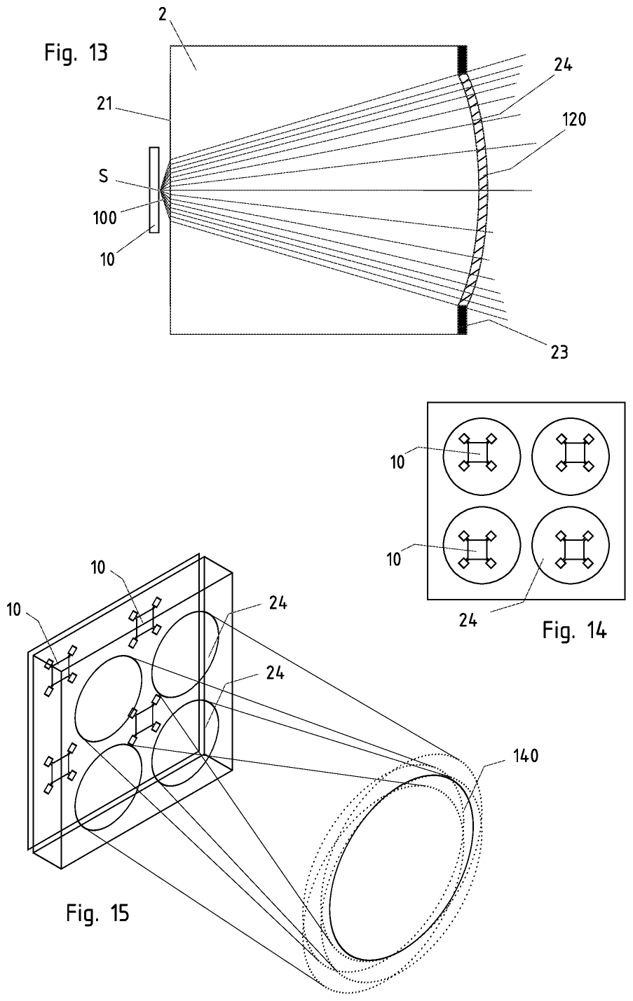

FIG. 13 shows an emitter device with a thermal source 10 and a transmissive element 2 configured as a thick lens 2 with a curved exit surface 22 covered by a thin filter layer 120. Remarkably, the curvature is chosen in a way that reduces the variations in the angle between the light rays crossing the exit surface and the surface itself, which is beneficial, because it mitigates the problems related to the angular dependence of the filter. By choosing the geometry carefully, light rays can be made essentially normal to the surface and to the filter layer, at least for a small thermal source; however, the invention does not require a perfect normal incidence everywhere.

The shift of the filter's central wavelength depends on the refractive index of the central layer of the filter. For each material, an angle range can be determined in which the shift of the central wavelength is not significative and can be neglected. If the shape of the exit surface is chosen such that the angle between the light rays and the normal remains in this angle range, the performance of the filter will be essentially the same as for a collimated source. The angle range is about ±8° for glass and glass-like windows. For silicon or similar materials, it could be as high as ±30°.

Preferably, the filter layer 120 is a thin film interference filter comprising a stack of dielectric layers deposited on the curved surface. The example depicted has a flat entry surface and a convex exit surface and is advantageous, because the curvature of the exit surface does not need to be extreme. Highly curved surface pose technical issues for depositing thin film filters. Other configurations are possible.

The example shown combines the filter on a curved surface with a lens close to the emitter membrane disclosed previously. This combination is particularly advantageous because it provides enhanced coupling and excellent light collection in a small package.

As the light leaving the emitter device is filtered and has a narrow bandwidth, it can be focused more effectively on smaller detectors. Small detectors can be cheaper and provide better performances and especially less noise, than large ones. Preferably, as disclosed in previous embodiments, the device may also include a blocking aperture around the curved exit surface of the lens, to prevent light from leaving the system at unwanted angles, for example a metallised reflective layer 23.

The emitter can be fabricated on a wafer, as it has been disclosed above. In this case, the transmissive optical element can also be fabricated in the same way. The filter layer 120 can be deposited on the lens. The fabrication process can be parallelised, to realize an integrated array of emitters, micro-lenses and filters that can be fabricated at wafer scale.

FIGS. 14 and 15 show a compound emitter with an array of several thermal sources 10, each facing the flat backside of an array of micro-lenses with a common plane entry surface on the backside and a plurality of convex surfaces 24 on the forward side, each covered by an optical filter.

FIG. 14 shows the array from the exit face, and FIG. 15 is a perspective view. FIG. 15 is not to scale: the distance between the source and the target has been artificially reduced for better legibility. The collimation introduced by the micro-lens array concentrates the light in the target spot 140.

The geometry can be optimised further by displacing slightly the lenses to enhance the overlap of the individual emission spots, as visible in FIG. 14, where the individual sources 10 are slightly offset outwards relative to the axis of the respective axis of the micro-lenses 24. The figures show four emitters, but the invention is not so limited. This variant is especially advantageous in spectrometers, for example, when it is desired to concentrate the radiation on a small-area detector.

Optionally, the emitter device could include a plurality of modules, each with an emitting refractory membrane, a transmissive element with a curved surface and a filter, as disclosed above, where the filters have different transmission functions, characterised by different central wavelengths and, possibly, bandwidths. In this variant, the wavelength emitted can be changed by selecting a subset of the modules, for example for on-band and off-band detection in a spectrometer system.

The arrangement described herein is particularly advantageous when the emitting surface is flat, and the back side of the micro-lenses is close to the emitter, as in the micro-emitters of the invention, otherwise the angle range would be too large. It would be much harder to obtain the same results with other sources with an irregular distribution of emission such as LEDs.

### REFERENCE SIGNS USED IN THE DRAWINGS

1 Thermal emitter device
2 Lens
3 Connection pad
4 Arm
5 Length of the arm
6 Width of the arm
7 Thickness of the arm
8 Housing
10 Thermal emitting membrane
11 First surface
12 Second surface
13 Support
21 Entry lens surface
22 Exit lens surface
23 Mirrored portion
24 Curved portion
26 Opening
20 Cold mirror
100 Emitted light
120 filter layer
140 target spot
200 Cold mirror
300 Optics
400 Second thermal emitter device
1000 Thermal emitter system
d Distance
P1, . . . Pj Powers
t Thickness of the lens
S Lambertian source
Ω1, Ω2 Solid angles

1. A light emitter module comprising:
a refractory membrane arranged to be heated to a thermal emission temperature such that an emitting surface of the membrane emits radiation in the IR and/or visible spectrum;
a transmissive optical element adjacent to the emitting surface comprising a curved surface configured such that at least a part of the radiation from the emitting surface enters the transmissive optical element and crosses the curved surface; and
an optical filter on the curved surface,
wherein the transmissive optical element has a reflectivity normal to the curved surface comprised in the range 4% to 40%, and
wherein a distance between the transmissive optical element and the emitting surface is equal or lower than L/4, where L denotes a largest transversal dimension of the refractory membrane.

2. The light emitter module of claim 1, wherein the optical filter is an interferential filter.

3. The light emitter module of claim 1, wherein the curved surface is a convex surface, and/or the transmissive optical element is a planoconvex lens.

4. The light emitter module of claim 1, wherein a distance between the transmissive optical element and the emitting surface is equal or lower than L/8.

5. The thermal emitter module of claim 1, wherein the transmissive optical element is made of glass, silicon, sapphire, quartz, germanium, and/or a MID-Far thermal material, such as CaF2, MgF2, ZnSe, ZnS, NaCl.

6. The thermal emitter module of claim 1,
wherein the refractory membrane is made by or comprises a refractory material, e.g., a refractory metal and/or an alloy of refractory metals and/or a refractory ceramic, or
wherein the refractory membrane is made of tungsten.

7. The thermal emitter module of claim 1, comprising a blocking aperture around the curved surface.

8. A compound emitter device including a plurality of the thermal emitting modules of claim 1.

9. The compound emitter device of claim 8, in which the optical filters of the thermal emitting modules have different central wavelengths and/or pass bandwidth, configured such that subsets of the thermal emitting modules can be selected and activated.

10. The compound emitter device of claim 8, wherein the radiation emitted by the thermal emitting modules is concentrated in a target spot.
